(19) United States
(12) Patent Application Publication
(10) Pub. No.: US 2010/0288724 A1
(43) Pub. Date: Nov. 18, 2010

(54) OVERPACK, METHOD FOR THE MANUFACTURE THEREOF

(76) Inventor: Andreas Jahn, Tabach-Dietharz (DE)

Correspondence Address: Muncy, Geissler, Olds & Lowe, PLLC, 4000 Legato Road, Suite 310, FAIRFAX, VA, 22033, US

(21) Appl. No.: 12/780,590

(22) Filed: May 14, 2010

(30) Foreign Application Priority Data
May 14, 2009 (DE) 10 2009 021 340.6

(51) Int. Cl. B65D 23/12; B23P 17/04

(52) U.S. Cl. 215/386; 29/527.1

(57) ABSTRACT

An overpack for a beverage bottle comprising a housing which includes at least one side wall element and a base element, the side wall element and the base element being a common extruded part formed during an extrusion process. A method for manufacturing an overpack for a beverage bottle is also provided that comprising a housing, the housing being formed by at least one side wall element and a base element. The side wall element and the base element are produced together as an extruded part produced in an extrusion process.

This nonprovisional application claims priority under 35 U.S.C. §119(a) to German Patent Application No. 10 2009 021 340.6, which was filed in Germany on May 14, 2009, and which is herein incorporated by reference.

### BACKGROUND OF THE INVENTION

1. Field of the Invention

The invention relates to an overpack for a beverage bottle, comprising a housing which has at least one side wall element and a base element. The invention further relates to a method for manufacturing an overpack for a beverage bottle, comprising a housing, the housing being formed by at least one side wall element and a base element.

2. Description of the Background Art

From the conventional art it is generally known that overpacks for products, in particular for beverage containers such as glass bottles for liquor, have a multi-part design. Overpacks are understood to be additional packaging that is not needed to package a product, but is used in addition thereto. These overpacks include, for example, a side wall element, in particular a tubular casing which is made of rolled cardboard or rolled and seamed sheet metal. This tubular casing is closed at the bottom by a base element for producing the overpack, the base element being connected to the side wall element, for example, by pressing, seaming, gluing or other methods.

### SUMMARY OF THE INVENTION

It is an object of the present invention to provide an overpack for a beverage bottle which is improved over the conventional art, comprising a housing, and to provide an improved method for manufacturing an overpack of this type.

The overpack for a beverage bottle, comprising a housing which includes at least one side wall element and a base element includes a side wall element and the base element that can be a common extruded part formed during an extrusion process.

The overpack can be designed in this manner to be tightly sealed against incoming and exiting external substances in the area between the side wall element and the base element. This makes it possible to fill the overpack with liquids or ice and to use it, for example, as a cooling container for beverage bottles such as bottles for liquor, since this prevents the liquids or molten ice from exiting through the integrally connected and leak-proof connection between the side wall element and the base element. In addition to being leak-proof, the overpack is also characterized by high strength and a particularly good surface quality.

At least one holding/fixing element for fixing the beverage bottle in place can be situated inside the housing, the holding/fixing element being an extruded part formed together with the side wall element and the base element during the extrusion process.

In an embodiment of the overpack, the side wall element, the base element and the holding/fixing element have a shape that corresponds to at least sections of the beverage bottle, so that the beverage bottle is held securely in place in the overpack.

As an alternative or in addition, a cooling element is situated inside the housing, thereby achieving or further increasing a good thermal insulation.

The cooling element is also producible during the extrusion process, so that the overpack may be manufactured at very low production cost, and the cooling element is designed to fit tightly against the inside of the overpack.

Furthermore, the housing can have a cover element on a side diametrically opposed to the base element, this cover element having a shape which corresponds, in particular, to at least sections of the product and/or having at least one opening corresponding to the sections for accommodating the neck of a bottle.

According to an embodiment of the overpack, the side wall element, the base element, the holding/fixing element, the cooling element and/or the cover element can be formed from the same material, the material being plastic or metal. On the one hand, these materials are particularly suitable for easy processing during the extrusion process and, on the other hand, the overpack is characterized thereby as a homogeneous component which has a particularly stable design. This avoids or at least reduces, in particular, deformations of the overpack by the effects of mechanical forces or temperature fluctuations when used as a cooling container.

In the method for manufacturing an overpack for a beverage bottle, comprising a housing, the housing being formed by at least one side wall element and a base element, the side wall element and the base element are produced together according to the invention as an extruded product produced in an extrusion process. This method advantageously saves considerable material and time and thus enables the overpack to be manufactured economically. Further advantages of the method lie in low tool costs, long tool life, high working speed and the possibility of a high volume output. The method may also be used to implement a wide range of overpack shapes, in particular even complex ones, it being easily possible to also produce additional design elements on the overpack.

According to one embodiment, at least one holding/fixing element and/or a cooling element is/are produced inside the housing in a particularly time-saving and material-saving manner during the extrusion process.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a first embodiment of an overpack;

FIG. 2A shows a schematic representation of a second embodiment of an overpack, having a first cover element;

FIG. 2B shows a schematic representation of the second embodiment of the overpack according to FIG. 2A, having a second cover element;

FIG. 2C shows a schematic representation of the second embodiment of the overpack according to FIG. 2A, having a third cover element;

FIG. 3 shows a schematic representation of a third embodiment of an overpack, having a first cover element for passage of the neck of a bottle;

FIG. 4 shows a schematic representation of a fourth embodiment of an overpack, having a first cover element for passage of the neck of a bottle;

FIG. 5 shows a schematic representation of fifth embodiment of an overpack;

FIGS. 6A through 6E show schematic representations of different outer shapes of overpacks; and

FIGS. 7A through 7H show schematic representations of different cross-sections of overpacks.

### DETAILED DESCRIPTION

Corresponding parts are provided with the same reference characters in all figures.

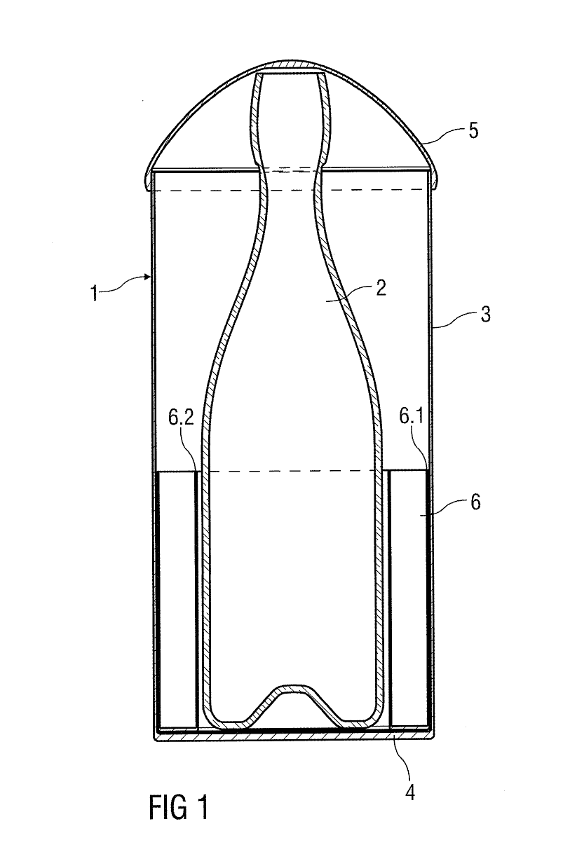

FIG. 1 shows a first embodiment of an overpack, comprising a housing 1, which is provided, for example, for packaging a beverage bottle 2, for example for liquor.

Housing 1 can be made from a jacket-like side wall element 3, a circular base element 4, a cover element 5 and a cooling element 6 and provided with a cylindrical design. The height of side wall element 3 is less than the height of beverage bottle 2, so that [the beverage bottle] projects into cover element 5 beyond an upper edge of side wall element 3.

Side wall element 3, base element 4 and cooling element 6 are manufactured together in an extrusion process, so that they form a common extruded part which is characterized by its homogeneity and leak-proofness. Side wall element 3, base element 4 and cooling element 6 are made from the same material, in particular from plastic or metal. These materials are particularly suitable for processing in an extrusion method, aluminum being preferably used as the metal, since it has particularly advantageous properties with regard to processing in an extrusion process.

Cooling element 6 has a cup-shaped design, an area between an outer jacket surface 6.1 and an inner jacket surface 6.2 situated concentrically thereto being provided for accommodating ice and thus for cooling beverage bottle 2.

The ice may be easily filled into the overpack from above while cover element 5 is open and enables beverage bottle 2 to be effectively cooled. The overpack may thus be used for packaging beverage bottle 2, which is provided both for protection and marketing purposes, and also as a cooling container for beverage bottle 2.

The leak-proof design of the overpack in the area of side wall element 3, base element 4 and cooling element 6 prevents water produced by molten ice from exiting the overpack.

In an alternative embodiment, which is not illustrated in greater detail, cooling element 6 is a separately produced component, which is inserted into housing 1 [during] the extrusion process.

Cooling element 6 is also designed in such a way that its shape corresponds to the shape of beverage bottle 2, so that the bottle is held securely in place in the overpack.

To also hold beverage bottle 2 securely in place in the upper area of the overpack, cover element 6 is also provided with a design corresponding to beverage bottle 2 in such a way that beverage bottle 2 is additionally held securely in place, in particular, in the area of the bottle neck.

In the illustrated exemplary embodiment of the overpack, cover element 5 is a cap having a lower area which is designed in such a way that its shape and inner diameter correspond to the shape and outer diameter of side wall element 3, so that cover element 5 may be placed on and overlap side wall element 3. The overpack may thus be closed firmly and, in particular, tightly by cover element 5.

According to a refinement of the invention, which is not illustrated in further detail, at least one sealing element is situated between cover element 5 and side wall element 3. This particularly advantageously achieves a lesser degree of heat exchange with the environment, making it possible to maintain a lower temperature achieved by cooling with the aid of the ice while the overpack is closed.

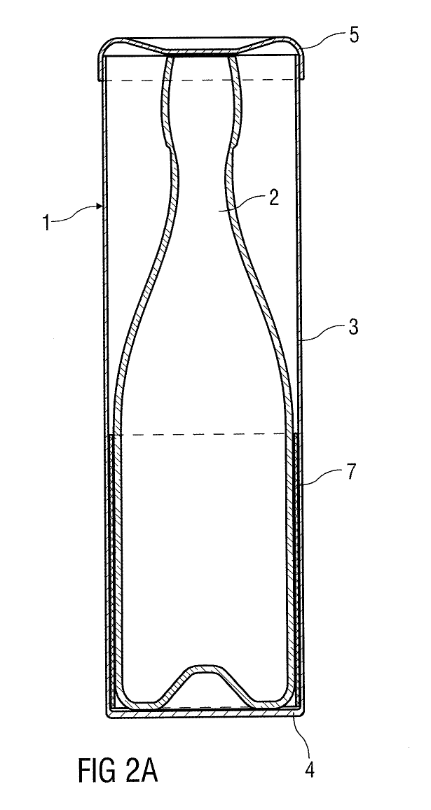

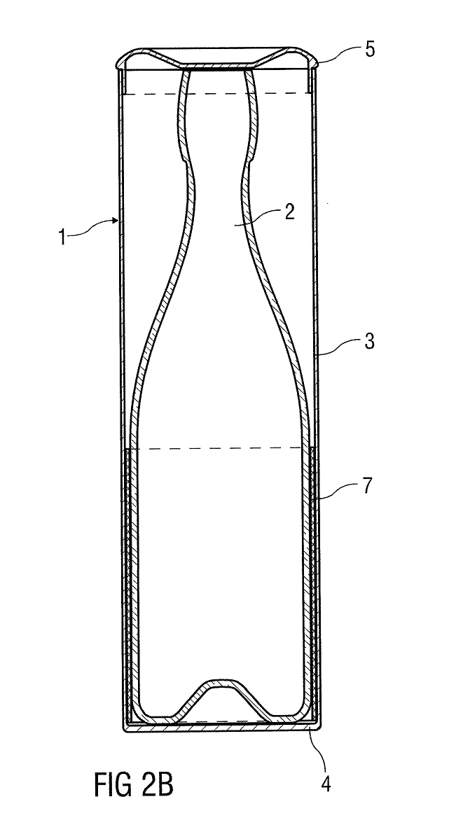

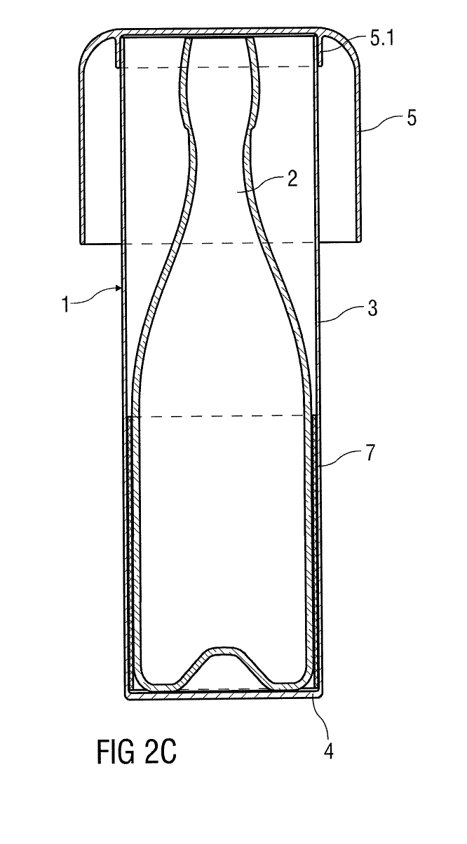

FIG. 2A shows a second embodiment of the overpack, side wall element 3 and base element 4 again being manufactured as a common extruded part in the extrusion process.

The height of side wall element 3 is equal to the height of beverage bottle 2, so that the neck of the bottle ends flush with the upper end of side wall element 3.

To securely hold beverage bottle 2 in place in the overpack in the vertical direction, cover element 5 is again designed as a cap having an indentation which is in contact with the upper end of beverage bottle 2 when cover element 5 is closed, thereby supporting the beverage bottle in the vertical direction.

Cover element 5 has a lower area which is designed in such a way that its shape and inner diameter correspond to the shape and outer diameter of side wall element 3, so that cover element 5 may be placed on and overlap side wall element 3. The overpack may thus be closed firmly and, in particular, tightly by cover element 5.

In a lower area, a sleeve 7, which fully surrounds beverage bottle 2 in this area and is preferably made of cardboard or plastic, is situated between side wall element 3 and beverage bottle 2. This sleeve 7 prevents beverage bottle 2 from moving within the overpack in the transverse direction.

FIG. 2B shows the overpack comprising housing 1 according to FIG. 2A, having an alternative cover element 5.

In contrast to the exemplary embodiment illustrated in FIG. 2A, cover element 5 has a lower area which is designed in such a way that its shape and outer diameter correspond to the shape and inner diameter of side wall element 3, so that cover element 5 may be placed on and project into side wall element 3. Cover element 5 is designed to project out of the lower area on the side, thereby forming an edge which may be used to support cover element 5 on the upper edge of side wall element 3.

FIG. 2C again shows the overpack comprising housing 1 according to FIG. 2A, having a further alternative cover element 5.

Cover element 5 has a cup-shaped design and is situated in such a manner that its opening to base element 4 faces side wall element 3. To achieve a firmly and tightly sealed overpack, a circular strip 5.1 in the base area of cover element 5, whose shape and inner diameter corresponds to the shape and outer diameter of side wall element 3, is situated in the base area of cover element 5 and is oriented in the direction of the opening therein, so that cover element 5 may be placed on and overlap side wall element 3 and strip 5.1.

Cover element 5, which has a cup-shaped design, may be advantageously used, not only to close the overpack, but also as a drinking vessel and/or measuring cup for the liquid contained in beverage bottle 2.

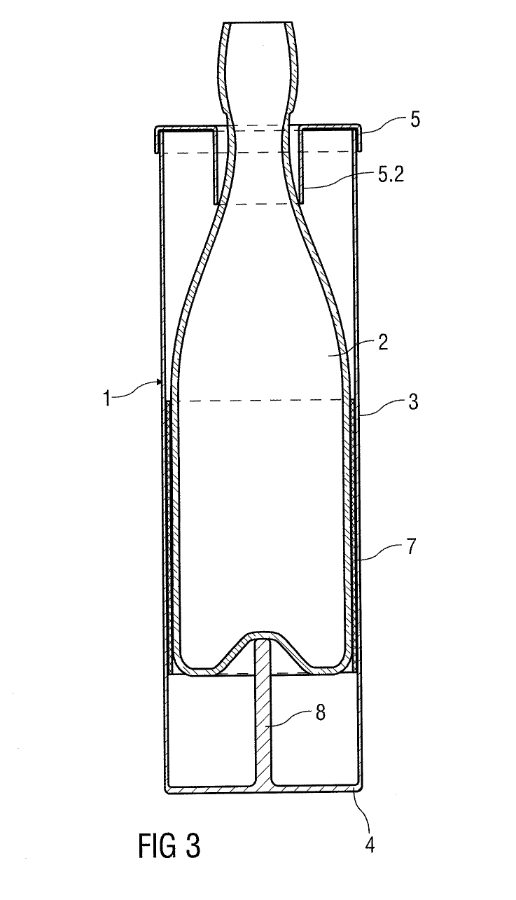

FIG. 3 shows a third embodiment of the overpack. In this case, a holding/fixing element 8, which is oriented upward from base element 4 in the vertical direction and projects into an indentation in the base of the bottle, is situated inside housing 1. As a result, a space is formed between the base of the bottle and base element 4 of housing 1, which may be filled, in particular, with ice for cooling beverage bottle 2.

For this purpose, cover element 5 is removed from housing 1, beverage bottle 2 is withdrawn from housing 1 and the space is filled with the ice. Beverage bottle 2 is then reinserted into housing 1, it being possible to re-close housing 1 by means of cover element 5.

Holding/fixing element 8 is formed together with side wall element 3 and base element 4 during the extrusion process, so that they form a common extruded part.

Cover element 5 has an edge which is provided with an angle design in such a manner that its shape and inner diameter correspond to the shape and outer diameter of side wall element 3, so that cover element 5 may be placed on and overlap side wall element 3.

Furthermore, cover element 5 has a circular strip 5.2 oriented in the direction of base element 4, whose height is designed in such a way that strip 5.2 is supported on beverage bottle 2 when cover element 5 is closed, thereby preventing the beverage bottle from moving vertically in the overpack. The height of strip 5.2 is varied, depending on the design and dimensions of beverage bottle 2.

In the area between strip 5.2, cover element 5 is designed to be open, so that beverage bottle 2 is situated in such a way that its bottle neck projects through cover element 5. This results in the particular advantage that beverage bottle 2 does not have to be removed from the overpack in order to be emptied and therefore may be continuously cooled with the aid of the ice.

To prevent transverse movement of beverage bottle 2 within the overpack, sleeve 7 is again situated between beverage bottle 2 and side wall element 3.

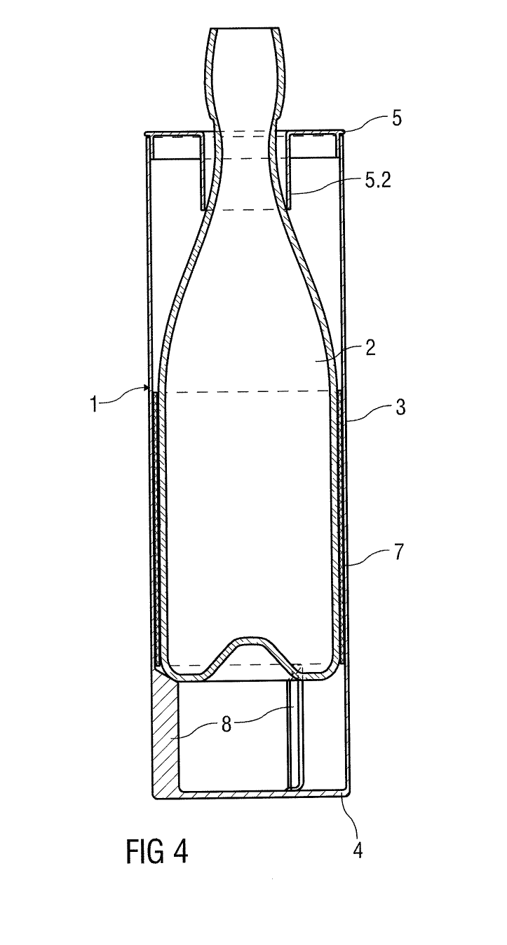

FIG. 4 shows a fourth embodiment of housing 1 of the overpack, in which fixing/holding element 8 is formed by three strips which face inward from side wall element 3 in the radial direction and extend upward at right angles from base element 4, the strips being situated at an equal distance apart on the inner circumference of side wall element 3. This again produces a space beneath the base of the bottle and above base element 4 of housing 1, which may be filled with ice in the same manner as in the overpack illustrated in FIG. 3.

Fixing/holding element 8 is likewise formed together with side wall element 3 and base element 4 during the extrusion process, so that they form a common extruded part.

Cover element 5 again has an edge area which is provided with an angled design in such a manner that its shape and outer diameter correspond to the shape and inner diameter of side wall element 3, so that cover element 5 may be situated on and project into side wall element 3.

Furthermore, cover element 5 has a circular strip 5.2 according to FIG. 3, which is oriented in the direction of base element 4 and whose height is designed in such a way that strip 5.2 is supported on beverage bottle 2 when cover element 5 is closed, thereby preventing the beverage bottle from moving vertically in the overpack.

In the area between strip 5.2, cover element 5 is again designed to be open, so that beverage bottle 2 is situated in such a way that its bottle neck projects through cover element 5.

To prevent transverse movement of beverage bottle 2 within the overpack, sleeve 7 is again situated between beverage bottle 2 and side wall element 3.

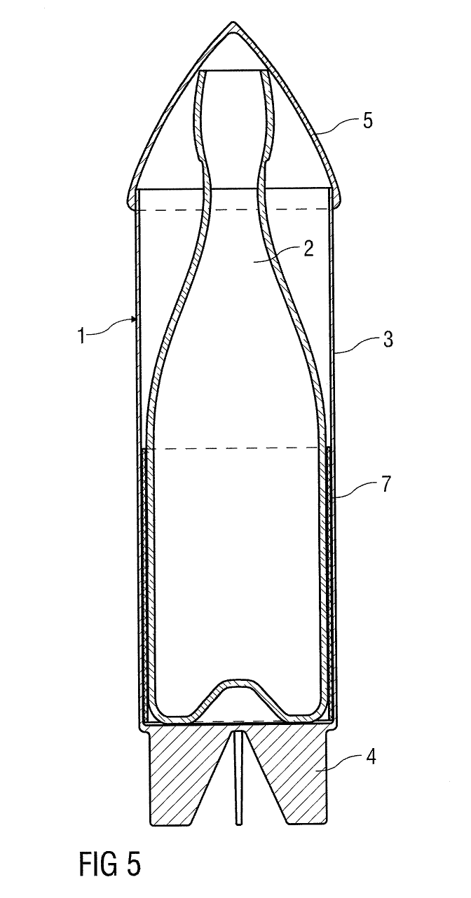

FIG. 5 shows a further exemplary embodiment of housing 1 of the overpack, having a rocket-shaped design. Base element 4, side wall element 3 and cover element 5 are designed in such a way that beverage bottle 2 is held securely in place in housing 1. To prevent lateral movement of beverage bottle 2 within the housing, sleeve 7 is again introduced between the bottle and side wall element 3.

Base element 4 is designed in such a way that it simulates a tail unit of a rocket, it being possible to produce this shape particularly easily by means of the extrusion process. Cover element 5 represents the pointed end of the rocket.

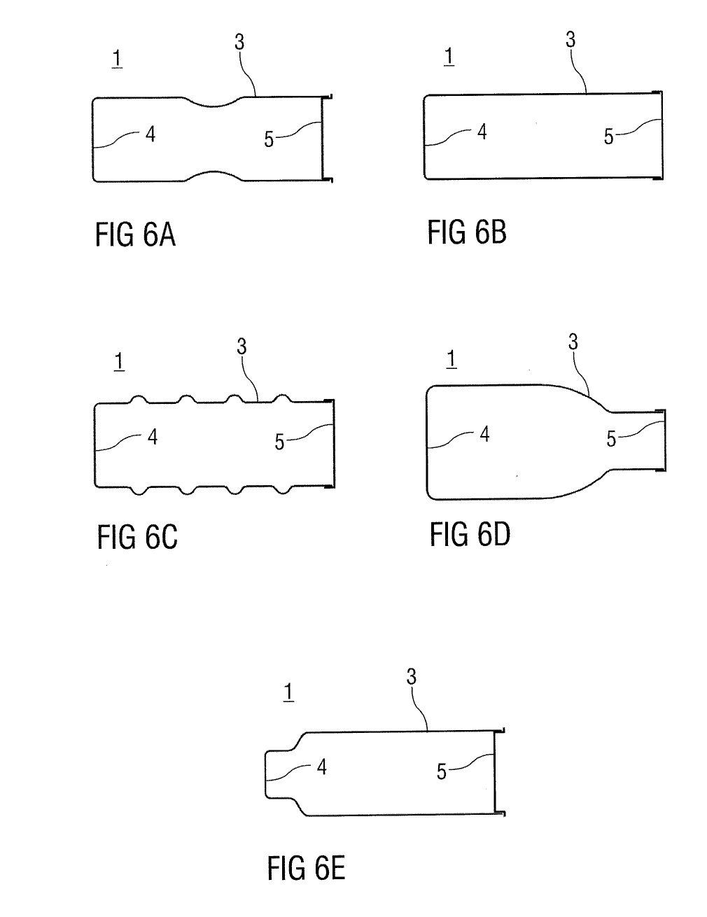

FIGS. 6A through 6E show different outer shapes of housing 1 of the overpack, which are provided with a largely cylindrical design. Depending on the application, side wall element 3, base element 4 and/or cover element 5 may have different designs, it being possible to produce a wide range of outer shapes, in particular complex outer shapes, using the extrusion method.

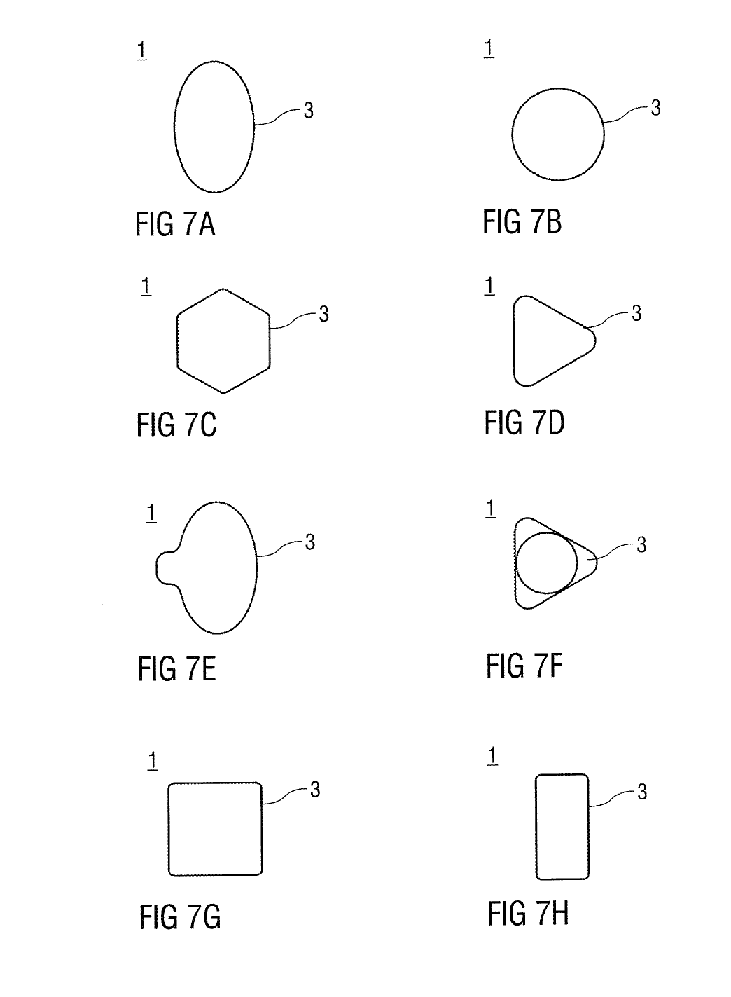

FIGS. 7A through 7H show different cross-sections of housing 1 of the overpack. In this case, both different cross-sections and different thicknesses of side wall element 3 may be particularly easily produced using the extrusion method.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An overpack for a beverage bottle comprising a housing that includes at least one side wall element and a base element, wherein the side wall element and the base element are a common extruded part formed during an extrusion process.

2. The overpack according to claim 1, wherein at least one holding/fixing element is provided within the housing for fixing the beverage bottle in place.

3. The overpack according to claim 2, wherein the holding/fixing element is a common extruded part formed by the side wall element and the base element during the extrusion process.

4. The overpack according to claim 2, wherein the side wall element, the base element and/or the holding/fixing element have a shape that corresponds at least to sections of the beverage bottle.

5. The overpack according to claim 1, wherein a cooling element is situated inside the housing.

6. The overpack according to claim 5, wherein the cooling element is a common extruded part formed by the side wall element and the base element and the holding/fixing element during the extrusion process.

7. The overpack according to claim 1, wherein the housing has a cover element on a side that is diametrically opposed to the base element.

8. The overpack according to claim 7, wherein the cover element has a shape that corresponds at least to sections of the product and/or has at least one opening corresponding to the sections for accommodating the neck of a bottle.

9. The overpack according to claim 7, wherein the side wall element, the base element, the holding/fixing element, the cooling element and/or the cover element are made from a same material, the material being plastic or metal.

10. A method for manufacturing an overpack for a beverage bottle comprising a housing, the method comprising:
forming the housing by at least one side wall element and a base element; and
producing the side wall element and the base element together as an extruded part produced in an extrusion process.

11. The method according to claim 10, wherein at least one holding/fixing element and/or a cooling element is/are produced inside the housing during the extrusion process.
